(19) United States
(12) Patent Application Publication
(10) Pub. No.: US 2012/0014210 A1
(43) Pub. Date: Jan. 19, 2012

(54) MULTIFUNCTIONAL MIXER

(76) Inventor: Hongfu Wang, Henan Province (CN)

(21) Appl. No.: 13/056,300

(22) PCT Filed: Jul. 22, 2009
(86) PCT No.: PCT/CN09/72870

§ 371 Date: Sep. 30, 2011

(30) Foreign Application Priority Data
Jul. 28, 2008 (CN) 200810140842.1

(51) Int. Cl. B01F 9/00

(52) U.S. Cl. 366/343

(57) ABSTRACT

A multi-functional stirrer includes a frame, a container, a beater and a driving mechanism. A circular rail is installed at a lower portion of the frame; a bottom of the vertical cylindrical shaped container is a conical shaped barrel bottom which can be driven to lift up and down by a lifting mechanism automatically; the driving mechanism drives a container assembly to rotate on the circular rail of the frame in a direction opposite to a rotation direction of the beater at the same time of driving the beater to rotate; the beater is composed by fixing a plurality of stirring bars onto a horizontally arranged stirring bar frame; a rotation axis of the stirring bar frame is eccentrically disposed with respect to an axis of the vertical cylindrical shaped container. The present invention has different functions of mixing, peeling, cleaning, polishing and dampening, etc., when the stirring bars with different structures are used.

### TECHNICAL FIELD

The present invention relates to a multifunctional stirrer, which is applicable to industries such as grain processing, feedstuffs, chemical engineering, medicine, foodstuffs, plastic and building materials etc., and is widely used in the operations of mixing of solid particles or powder materials, peeling of grains, cleaning and polishing of surfaces of solid particle materials, and mixing of solid particles or powder materials with liquid materials, etc.

### BACKGROUND TECHNOLOGY

Theoretically, the operation of evenly intermingling materials in any state (solid state, liquid state, gas state and semi-liquid state) is called mixing. However, usually the operations of intermingling solid materials and dampening a solid material are called as mixing, and the operation of mixing material in a solid state, a liquid state or a gas state with material in a liquid state is called as stirring. A stirring device is composed of a frame, a container, a driving mechanism, a stirring shaft and a beater (impeller or vane). At present, there are many kinds of mixing equipments which are widely used in manufacturing and in daily life, and in general, the mixing machines are also composed of a frame, a container, a driving mechanism, a helical band or a coulter, etc. The mixing devices are categorized into a continuous type and an intermittent type according to structural characteristics and operational modes. Each type of mixing machines has its advantages and disadvantages. Furthermore, equipments in prior art, such as peeling machines, wheat scourers, polishing machines or dampeners, which are widely used in different fields and industries also have respectively some shortcomings which need to be overcome, respectively, and will be described respectively as follows.

1. Functional Characteristics and Shortcomings of Existing Mixing Devices:

Materials are fed in large flow accumulation type in the existing mixing devices (various materials are in a cluster state with clear boundaries before the mixing operation). Completion of mixing is realized only by stirring and turning a large amount of materials repeatedly during the mixing process carried by the devices, so the power consumption of the devices are always quite high. Furthermore, analyzed from the mixing mechanism, it will definitely appear that, during the mixing process of different mixing devices, the negative effect of segregation tendency is aggravated when the motion strength is large and the mixing effect is good. Therefore, all of the existing mixing devices have bad effects when they are used to mix the materials with great differences in granularity, density, shape, surface roughness, fluidity and other natures. Although the intermittent mixing devices which are widely used in different fields and industries have advantages of variety, good adaptability, stability and reliability in mixing uniformity, etc., they also have shortcomings, for example, big containers and large space are required, segregation phenomenon occurs during storage and transportation process after evenly-mixing, it is unable to meet the requirements of continuous and automatic production, and the environment is easily polluted during discharging, etc. A few of continuous mixing devices have advantages such as compact structure, less segregation phenomenon, adaptable to continuous and automatic production demand, and less environment pollution, etc., but they also have bad adaptability (not applicable to the situation where solid materials with greatly different granularity, density and shape, etc., are mixed with each other), and have bad and unstable mixing uniformity.

2. Structural Characteristics and Shortcomings of the Existing Peeling Machines:

A peeling machine is common equipment in the grain processing industry. Analyzed from the mechanical structure and functions, equipment which is used to remove the skin of wheat, peanut, maize and soybean is called a peeling machine, and a paddy pounder which is used to mill the skin of the brown rice also belongs to the category of peeling machines. The structure and the working principle of the existing peeling machines are mostly similar to the paddy pounders. Working parts of the peeling machine are mainly composed of a vertical or a horizontal cylindrical screening drum, a rotating steel roller or an emery roller which is installed at the axis of the screening drum, and a spiral propeller, etc. The spiral propeller pushes material particles and generates a pressure on the grain between the inner wall of the screening drum and the steel roller or the emery roller during the operation of the device, and at that moment, the rotation of the steel roller or the emery roller will roll and rub the surrounding grains to remove the skin of the grains. As cereal grains generally have characters such as various sizes, different shapes, and big difference in strength limitation, etc., to which the structure and working principle of the existing peeling machines cannot adapt, all existing peeling machines including the paddy pounder have the disadvantages of high energy consumption, incomplete peeling, and being liable to form broken kernel.

3. Structural Characteristics and Shortcomings of the Existing Wheat Scourers (Surface Cleaning Equipments):

A wheat scourer is a kind of common equipment used in the wheat surface cleaning process in a wheat flour production line. It is cleaning equipment which can clean wheat awn on wheat berry and dust adhered to wheat berry by striking the wheat in a cylindrical screening drum by means of a plate-making on the fast rotating rotor. Because of the factors that the strength of the wheat berry is different, instantaneous force applied by the plate-making of the wheat scourer to the wheat is large, and when the plate-making of the wheat scourer strikes the wheat repeatedly, the wheat should be pushed to the outlet from the feeding port of the equipment to accomplish the cleaning task, the existing wheat scourer has shortcomings such as having many vulnerable components, producing a few broken kernels during operation process, and having high energy consumption, etc.

4. Structural Characteristics and Shortcomings of the Rice Polishers:

The polishers used in the graining industry normally adopt a common steel roller for lightly-rubbing, and some polishers adopt polyurethane polishing bands with good flexibility and abrasion resistance. The structure of the polishing machines used in the rice graining industry is generally similar to that of a rice mill Therefore, they also have shortcomings such as high energy consumption, uneven friction, difficulties in operational control, and liable to produce broken kernels, etc.

5. Structural Characteristics and Shortcomings of the Existing Dampeners (Equipments for Mixing Liquid with Solid):

A dampener used in the food processing factories adopts a rotor plate-making or a stirring bar to repeatedly stir the particle material in the cylindrical container, and at the same time, water is injected through a water pipe so that the grain particles are evenly dipped with water. Since water is in a water column state at the moment when the water flows into the container through the pipe port, a small quantity of material particles close to the water column are immersed in the water, while most material particles which are far away from the water column are not dipped with any water. Therefore, the rotor of the dampener must rotate for tens of turns, and the plate-making or stirring bar shall repeatedly stir materials and push materials from a feeding port to a discharging port so as to realize the purpose of making the material particles generally dipped with water evenly. It is obvious that the centralized water injection method increases the workload, and pushing all materials from the feeding port of the dampener to the discharging port is also an additional workload. These two disadvantages in design make the existing dampener having a large volume, occupying big area, and consuming more energy.

As the present invention is a typical stirrer when it is categorized based on the structural characteristics of the equipment, while its function, purpose and effect are similar to many kinds of equipments described in the background, we call it a multifunctional stirrer.

### SUMMARY OF THE INVENTION

The object of the present invention is to provide a multifunctional stirrer with multiple functions of mixing solid particles or powder materials, peeling grains, cleaning and polishing the surfaces of solid particle materials, and mixing solid particle or powder materials with liquid materials, etc., by adopting a vertical rotating container with an automatic lifting barrel bottom, and a stirring-bar-styled beater which is away from the rotating axis of the container by an eccentric distance of certain value, and configuring with the stirring bar of various structures.

In order to realize the above object, the technical solution employed in the present invention is a multifunctional stirrer composed of a frame, a container, a beater and a driving mechanism, in which a circular rail is installed at the lower portion of the frame, and a bottom of the vertical cylindrical container is a conical barrel bottom which can be driven to lift up and down by a lifting mechanism automatically; the driving mechanism drives the container assembly to rotate on the circular rail of the frame in a direction opposite to the rotation direction of the beater while driving the beater to rotate; and the beater is formed by fixing a plurality of stirring bars on a horizontally placed stirring frame. The rotation axis of the stirring frame is eccentrically arranged with respect to the axis of the vertical cylindrical container.

The lifting mechanism is controllably connected to an electric automatic control device or a spring automatic control device.

The stirring frame of the beater is cross-shaped. The stirring bar frame is equipped with one kind of the stirring bars from the scrapping plate stirring bar, the scraping blade stirring bar, the sinter abrasive stirring bar and the inlaid polyurethane band stirring bar according to the usage requirements. The minimum distance between the outermost stirring bar and the inner wall of the container ranges from 10 mm to 15 mm, and a scrapping plate component is disposed at a position of the inner wall of the container which is far away from the stirring bar.

The automatic electrical control device is composed of an upper limit sensor, a lower limit sensor, a bearing box, a press plate, a tightening screw, a double direction thrust bearing, a tapered barrel bottom welded part, a barrel-shaped nut, a stepping motor, a supporting shaft seat welded part, and a supporting shaft welded part, wherein the supporting shaft welded part is composed of a cylindrical supporting shaft with a machined screw hole and a stage for installing the double direction thrust bearing at an upper portion thereof and a section of screw rod at a lower portion thereof, and a reversed L-shaped guiding rod made by rounded steel bar is welded to the right side of the cylindrical supporting shaft. The supporting shaft seat welded part is composed of a section of the cylindrical tubular supporting seat, an upper end of which is welded to a disc-shaped guiding plate, wherein the disc-shaped guiding plate is made from a thick steel plate, having a middle hole allowing the supporting shaft to slidably pass through and a side hole allowing the guiding rod to pass through; and an lower end of which is welded to a square flange, wherein the square flange is made by a steel plate, having a machined hole and a stage for connecting the stepping motor. An upper portion of the barrel-shaped nut is internal screw threads to match the screw rod at the lower portion of the supporting shaft welded part, and the lower portion of the barrel-shaped nut is a cylindrical part with a rounded hole to match with a shaft of the stepping motor. The upper limit sensor and the lower limit sensor are fixed on a cover plate. The flange at the lower end of the supporting shaft seat welded part is fixed on two transverse rods of an upper end of a material discharging barrel welded part. The upper end of the supporting shaft seat welded part matches the supporting shaft welded part connected to the tapered barrel bottom with the bearing box installed with the thrust bearing. The screw threads at the lower portion of the supporting shaft welded part match the barrel-shaped nut fixed on the shaft of the stepping motor. The stepping motor is fixed at the lower end of the supporting shaft seat welded part. When the present invention works, the stepping motor can be driven by signals from the upper limit sensor and the lower limit sensor via a control system to lift the tapered barrel bottom up and down.

The automatic spring control device is composed of a spring and a cylindrical spring seat fixed at the bottom of the container having a bossing for supporting the spring.

The scraper plate stirring bar is made by machining a slot at a certain angle with respect to a horizontal plane in a steel cylindrical scraper plate stirring bar body, and then welding or adhering a strip of small scraper plate to the slot.

The scraping blade stirring bar is made by machining a slot parallel to the axis of a scraping blade stirring bar body in the steel cylindrical scraping blade stirring bar body, and then welding or adhering a strip of scraping blade to the slot.

The sinter abrasive stirring bar is made by adhering or sintering silicon carbide abrasive to a steel cylindrical sinter abrasive stirring bar body.

The inlaid polyurethane band stirring bar is made by machining a dovetailed slot parallel to the axis of a steel cylindrical inlaid polyurethane band stirring bar body in the steel cylindrical inlaid polyurethane band stirring bar body, and inlaying to the dovetailed slot a polyurethane polishing band of isosceles trapezoid shape in cross-section.

The frame welded part includes three groove steel supporting trestles, wherein a square cushion plate is welded on the upper portion of each of the groove steel supporting trestles at a specified position, and a hole for allowing a screw rod of a top wheel component to pass through is machined at an appointed position thereof; a triangle support is welded on the lower portion of each of the groove steel supporting trestles at an appointed position; and a rectangle anchorage plate with an anchorage hole is welded to each of the low ends of the groove steel support trestles. Then, after the three groove steel supporting trestles with welded fittings are placed on trisecting positions of a specified circle according to design requirements, a steel round ring with drilled holes for connecting the cover plate is welded to the upper end of the groove steel supporting trestles, and a circular rail with a circular slot machined at an upper end face of the circular rail is welded to the lower portion of the three triangle supports at appointed positions, the circular slot is rounded in a vertical cross-section. Thus, the frame welded part is formed.

The container assembly is composed of a material barrel welded part, a material receiving tapered barrel welded part, a tapered barrel bottom welded part, a double direction thrust bearing, a bearing box and three roller components; wherein the main body of the material barrel welded part is a vertical cylindrical shaped material barrel; a ring gear, a lower portion of which is a section of circular ring used as a top wheel rail, is welded to an upper end of the material barrel; a material discharging tapered barrel, a lower end of which is bigger than an upper end thereof, is welded to a lower end of the material barrel; a material barrel flange with machined connection holes is welded to a lower end of the material discharging tapered barrel; a vertical guiding plate of right-angled trapezoid shape which is placed vertically is welded on each of quartering positions at the inner wall of the material discharging tapered pipe; the material receiving tapered barrel welded part is composed of a material receiving tapered barrel, of which an upper end is bigger than a lower end thereof; a material receiving barrel upper flange with machined connection holes is welded to an upper end of the material receiving tapered barrel, and a material receiving barrel lower flange is welded to a lower end of the material receiving tapered barrel; the tapered barrel bottom welded part is composed of a tapered barrel having an upper end smaller than a lower end thereof, a disc-shaped top plate welded to the upper end of the tapered barrel, and a disc-shaped base plate with a key slot machined at each of quartering positions on the outer circumference, which is welded to the lower end of the tapered barrel. The tapered barrel bottom welded part, installed with fittings such as the double direction thrust bearing, the bearing box, the supporting shaft welded part, etc., is placed between the material barrel welded part and the material receiving tapered barrel welded part in a manner of that the key slots on the outer circumference of the base plate of the tapered barrel bottom welded part are aligned with the vertical guiding plates at the bottom of the material barrel welded part; the material barrel welded part and the material receiving tapered barrel welded part are fixed into a whole with bolts and nuts, and then three roller components are installed at a lower end face of the material receiving barrel upper flange of the material receiving tapered barrel welded part at appointed positions. Thus, the container assembly is formed.

The driving mechanism is composed of a variable frequency control motor, a speed reducer, a gear, the container assembly and three top wheel components; the output shaft of the speed reducer installed on the cover plate is directly connected with the beater component in the container component by passing through the cover plate; and the variable frequency control motor installed on the cover plate is engaged with the gear installed on its shaft with a ring gear fixed at an upper end of the container assembly. The four vertical guiding plates belonging to the container assembly at a lower end of the material barrel welded part are inserted into the four key slots at the outer circumference of the tapered barrel bottom; the speed reducer drives the beater to rotate; the variable frequency control motor drives the whole container assembly together with material in the container to rotate on the circular rail of the frame through the engagement between the gear and the ring gear, and the mating between the vertical guiding plates and the key slots; and the horizontal position of the container assembly can be adjusted by adjusting the positions of nuts on the screw rods of the three top wheel components installed at the upper portion of the frame welded part so as to ensure good engagement between the gear and the ring gear, and stable operation of the container assembly.

Since both of the container and the beater in the present invention are rotatable, and there is an eccentric distance of a certain value between the rotation axis of the container and the rotation axis of the beater, this design with an eccentricity can ensure that all the materials around the corners except those close to the inner wall of the container (10 mm to 15 mm away from the inner wall) can be stirred by the stirring bars of the beater during each turn of the container rotation, and the scraper plate installed close to the inner wall of container can scrape the materials close to the inner wall of the container which cannot be stirred by the stirring bar toward the axis of the container. Therefore, there is no dead corner of stirring during the operation of the present invention. The container rotates at an even speed during the operation of the present invention, the entering of the solid or liquid materials to the container through a slot-shaped feeding port and a spraying pipe placed on the cover plate is equivalent to being evenly sprayed or sprinkled on the upper surface of the container. That is, as soon as each kind of material enters the container, they are in a macroscopic even distribution state. It not only greatly improves working efficiency of the equipment, reduces operation time and energy consumption, but also obviously improves working quality and process effect of the equipment. The stiffing strength can be increased when the rotation direction of the container is opposite to that of the beater. The automatic control device is adopted to control the tapered barrel bottom at the bottom of the container to move up and down automatically, and thus the gap between the outer circumference of tapered barrel bottom and the inner wall of the material discharging tapered pipe at the bottom of the container is changed so as to control the flow rate of the discharging material and the height of material level in the container. First, it can realize automatic discharging and flowing of the material and save a large amount of energy power; second, it can maintain a stable material level in the container and ensure stable and reliable functions of mixing, peeling, cleaning, polishing and dampening, etc. Since the container in the present invention rotates by means of three rollers equipped with bearings rotating smoothly, the energy consumption is very low. The contact area between the material and the stirring bar is small during the rotation of the stirring bar of the beater which is suspended and fixed on the shaft end of the speed reducer, which results in a small amplitude of a forced movement of the material particle, and in turn the energy consumption is very low. Thus, energy saving is one big advantage of the present invention. The embodiment 1 of present invention is a stirring mixer used for mixing solid particle materials or powder materials, and the stirring mixer adopts scraper plate stirring bars equipped with small inclined scraper plates; the embodiment 2 of the present invention is a stirring peeling machine used for peeling grains, and the stirring peeling machine adopts scraping blade stirring bars equipped with axial scarper blades; the embodiment 3 of the present invention is a stirring cleaning machine used for cleaning the surface of solid particles material, and the stirring cleaning machine adopts sinter abrasive stirring bars with adhered or sintered silicon carbide abrasive; the embodiment 4 of the present invention is a stirring polishing machine used for polishing the surface of grains, and the stirring polishing machine adopts inlaid polyurethane band stirring bars with inlaid polyurethane bands; the embodiment 5 of the present invention is a stirring dampener used for mixing solid particle or powder material with liquid material, and the stirring dampener adopts a round steel stirring bar made of a smooth round steel bar. Multiple functions of mixing, peeling, cleaning, polishing and dampening, etc., can be realized when the stirring bars of different structure in the invention are replaced. Thus, realizing multiple functions by a single machine is also a big advantage of the present invention. Compared with the prior art, the advantages of the five embodiments of the present inventions mentioned above will be described after the description of the drawings.

### DESCRIPTION OF THE DRAWINGS

FIG. 1 is a front view and schematic diagram of the general structure of the present invention;

FIG. 2 is a top view of the stiffing mixer in the embodiment 1 of the present invention (three materials are mixed in the embodiment 1 shown in FIG. 2, so that there are three feeding ports on the cover plate), assuming that the partial cover plate of the stirring mixer in the schematic diagram of the general structure is removed;

FIG. 3 is a schematic diagram of the structure of the material barrel welded part in the present invention;

FIG. 4 is a schematic diagram of the structure of the tapered barrel bottom welded part in the present invention;

FIG. 5 is a schematic diagram of the structure of the supporting shaft welded part in the present invention;

FIG. 6 is a schematic diagram of the structure of the supporting shaft seat welded part in the present invention;

FIG. 7 is a schematic diagram of the structure of the material receiving tapered barrel welded part in the present invention;

FIG. 8 is a schematic diagram of the structure of the material discharging tapered barrel welded part in the present invention;

FIG. 9 is a schematic diagram of the structure of the frame welded part in the present invention;

FIG. 10 is a schematic diagram of the structure of the beater components in the present invention;

FIG. 11 is a front view, a left view and a top view of the structure of the scrapper component in the present invention;

FIG. 12 is a schematic diagram of the structure of the top wheel components in the present invention;

FIG. 13 is a front view and a top view schematically showing the structure of the roller component in the present invention;

FIG. 14 is a schematic diagram of the structure of the electric material level automatic control device in the present invention;

FIG. 15 is a schematic diagram of the structure of the container assemblies in the present invention;

FIG. 16 is a schematic diagram of the structure of the driving mechanism in the present invention;

FIG. 17 is a schematic diagram of the structure of the scrapper stirring bar used in the stirring mixing machine in the embodiment 1 of the present invention;

FIG. 18 is a schematic diagram of the structure scrapper plate stirring bar used in the peeling stirring machine in embodiment 2 of the present invention;

FIG. 19 is a schematic diagram of the structure of the sinter abrasive stirring bar used in the stirring cleaning machine in embodiment 3 of the present invention;

FIG. 20 is a schematic diagram of the structure of the inlaid polyurethane band stirring bar used in the stirring polishing machine in embodiment 4 of the present invention;

FIG. 21 is a schematic diagram of the structure of the round steel stirring bar used in the stirring dampener in embodiment 5 of the present invention;

FIG. 22 is a top view of the peeling machine, cleaning machine, polishing machine and dampener used in embodiment 2, embodiment 3, embodiment 4 and embodiment 5 (only one kind of solid material enters the container, so there is only one feeding port), assuming that a partial cover plate in the general schematic diagram of the structure is removed;

FIG. 23 is a schematic diagram of the structure of the automatic control device in the present invention when spring automatic material level control equipment is adopted.

### REFERENCE NUMERALS IN THE DRAWINGS

1 material barrel welded part, 2 beater component, 3 driving mechanism, 4 cover plate, 5 top wheel component, 6 scraper plate component, 7 tapered barrel bottom welded part, 8 supporting shaft welded part, 9 supporting shaft seat welded part, 10 material receiving tapered barrel welded part, 11 roller component, 12 material discharging tapered barrel welded part, 13 electric material level automatic control equipment, 14 frame welded part, 15 material feeding port, 16 ring gear, 17 material barrel, 18 material discharging tapered pipe, 19 vertical guiding plate, 20 material barrel flange, 21 top plate, 22 tapered barrel, 23 base plate, 24 supporting shaft, 25 guiding rod, 26 guiding plate, 27 tubular supporting seat, 28 square flange, 29 material receiving barrel upper flange, 30 material receiving tapered barrel, 31 material receiving barrel lower flange, 32 material discharging barrel upper flange, 33 horizontal rod, 34 material discharging tapered barrel, 35 material discharging barrel lower flange, 36 circular ring, 37 cushion plate, 38 groove steel supporting trestle, 39 circular rail, 40 triangle support, 41 anchorage plate, 42 nut-washer, 43 stirring frame, 44 stirring bar, 45 scraper plate frame, 46 bolt and nut, 47 scraper plate, 48 top wheel, 49 press plate, 50 screw, 51 bearing, 52 washer, 53 top wheel shaft, 54 top wheel frame, 55 spring washer, 56 screw, 57 nut, 58 roller frame, 59 roller, 60 bearing, 61 spring washer, 62 roller shaft, 63 washer, 64 press plate, 65 screw, 66 upper limit sensor, 67 lower limit sensor, 68 bearing box, 69 press plate, 70 tightening screw, 71 double direction thrust bearing, 72 barrel-shaped nut, 73 stepping motor, 74 container assembly, 75 variable frequency control motor, 76 speed reducer, 77 gear, 78 scraper plate stirring bar, 79 scraper plate stirring bar body, 80 small scraper plate, 81 scraping blade stirring bar, 82 scraping blade stirring bar body, 83 scrapping blade, 84 sinter abrasive stirring bar, 85 sinter abrasive stirring bar body, 86 silicon carbide abrasive, 87 inlaid polyurethane band stirring bar, 88 inlaid polyurethane band stirring bar body, 89 polyurethane band, 90 round steel stirring bar, 91 spraying pipe, 92 spring, 93 spring seat.

### DETAILED EMBODIMENTS

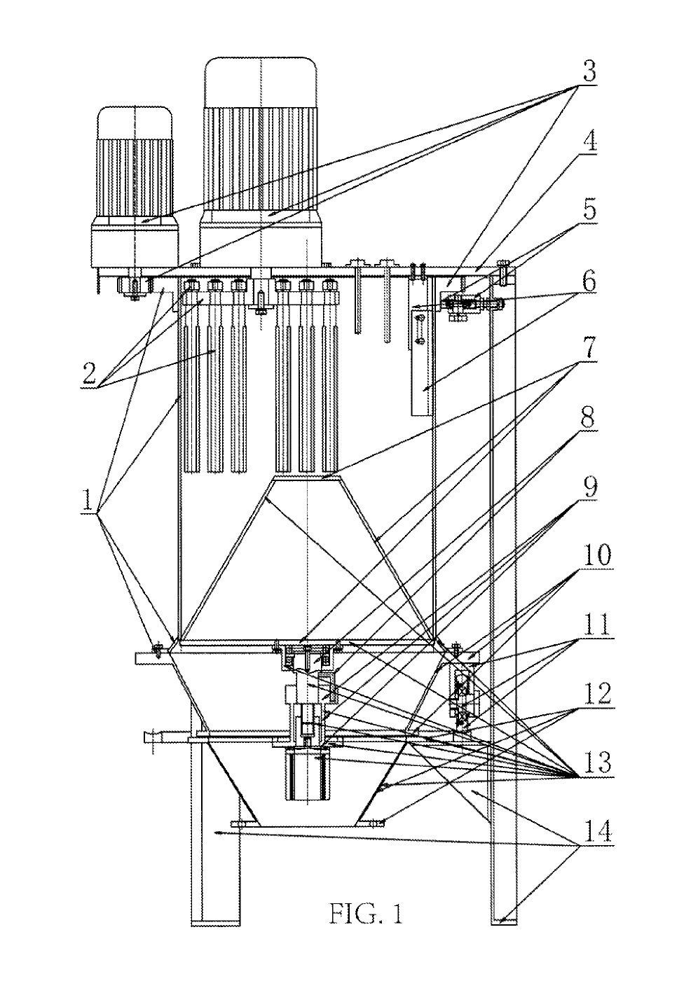

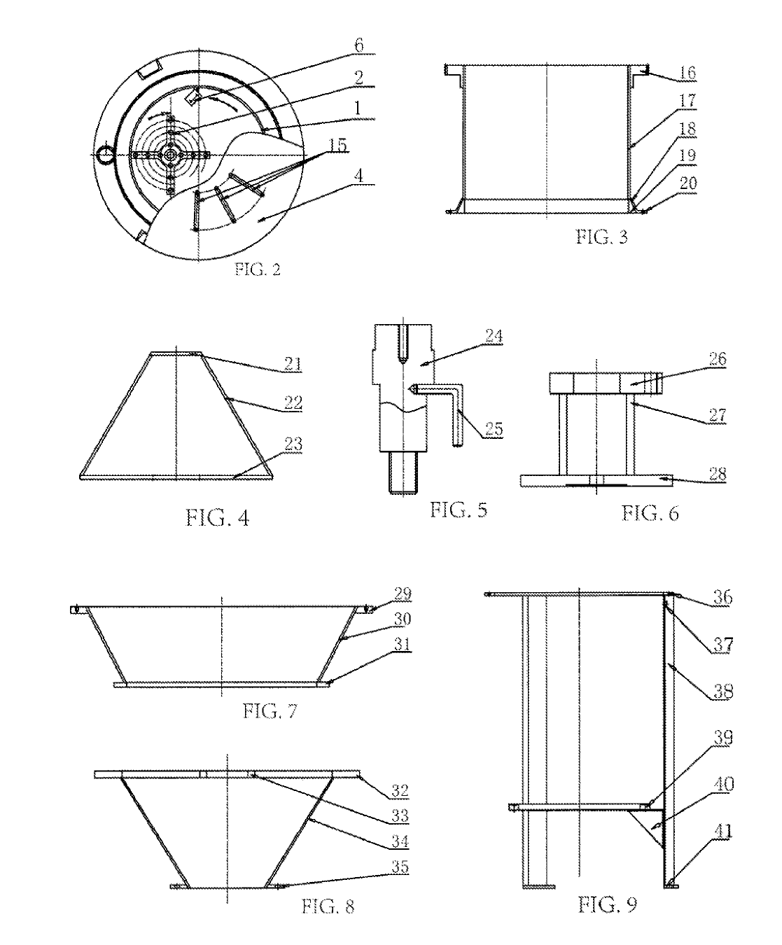

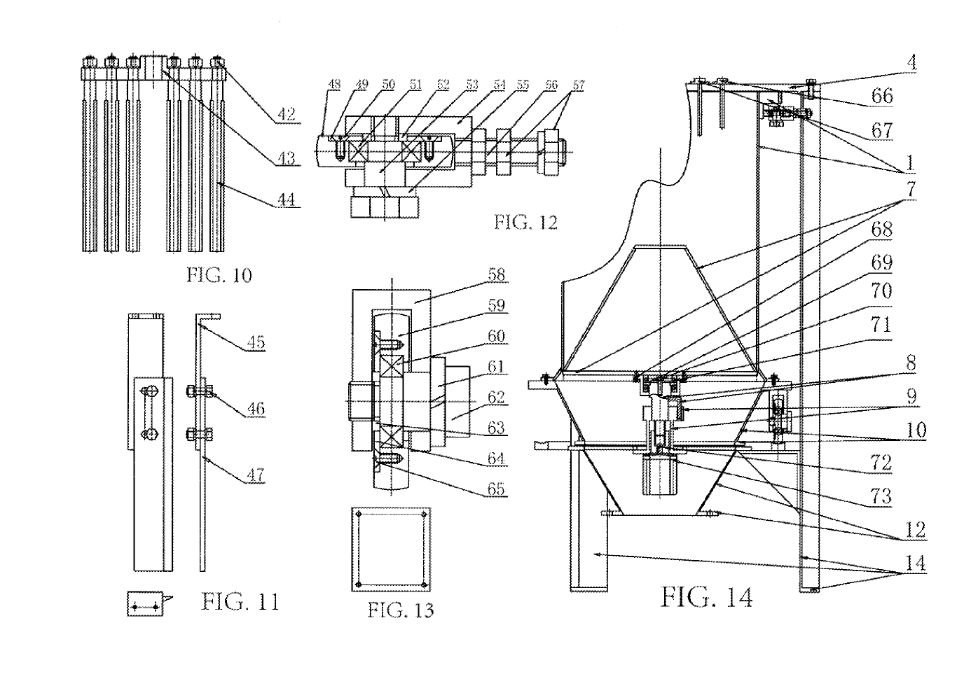

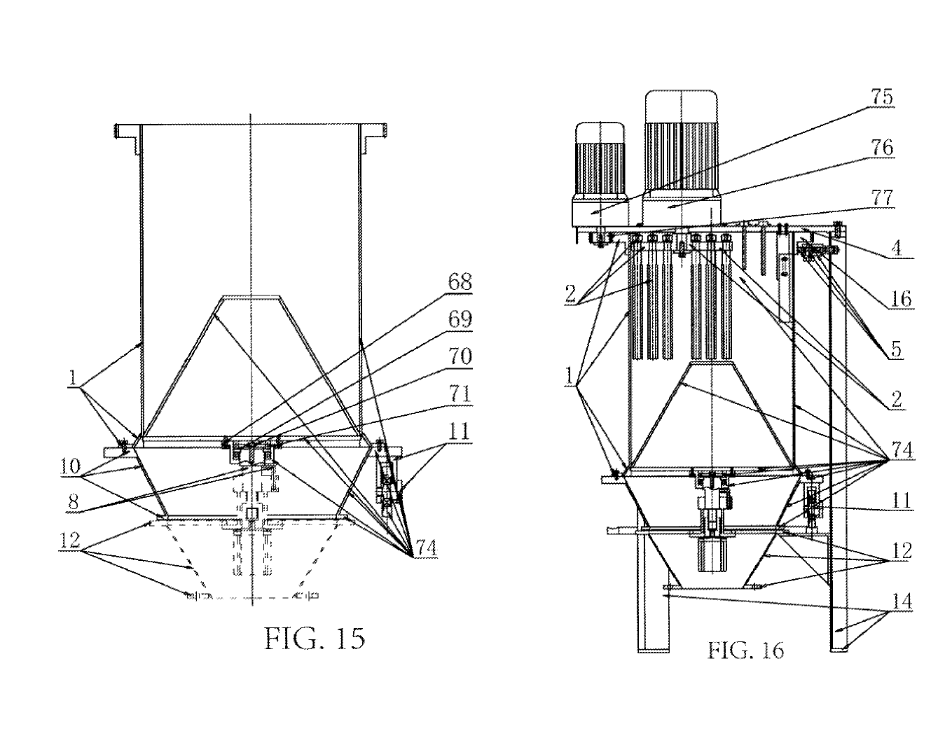

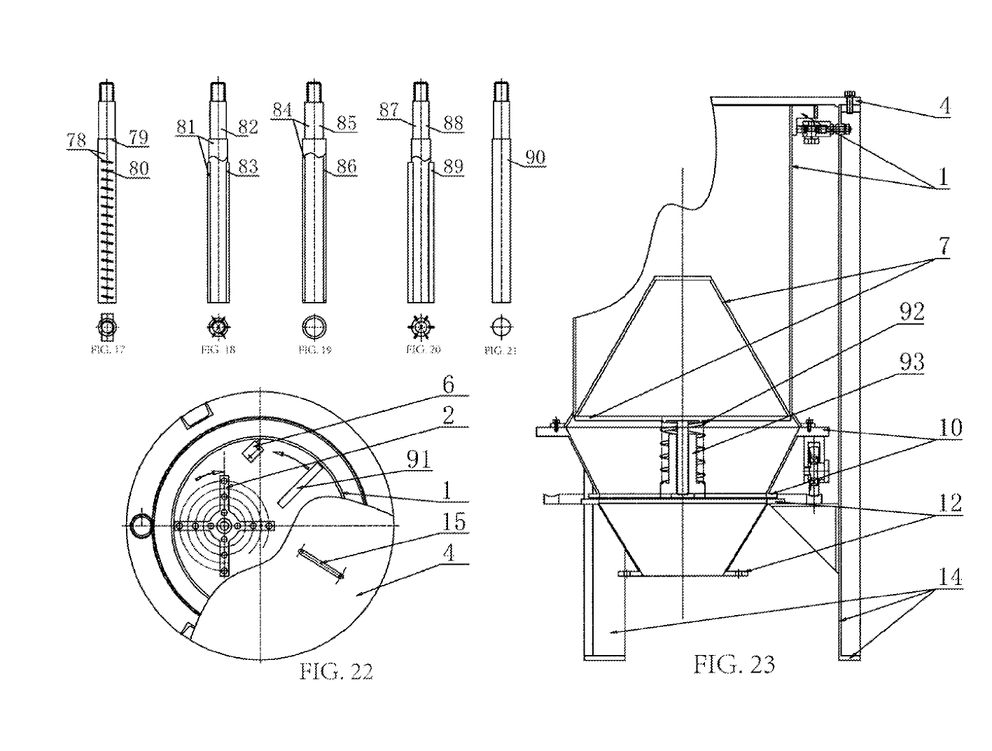

As shown in FIG. 1, the present invention is composed of a material barrel welded part 1, a beater component 2, a driving mechanism 3, a cover plate 4, a top wheel component 5, a scraper plate component 6, a tapered barrel bottom welded part 7, a supporting shaft welded part 8, a supporting shaft seat welded part 9, a material receiving tapered barrel welded part 10, a roller component 11, a material discharging tapered barrel welded part 12, an electric material level automatic control equipment 13 and a frame welded part 14. As shown in FIG. 2, there is a specific eccentric distance between the rotating axis of the beater component 2 and that of the container assembly 74 in this invention, and the rotation direction of the beater component 2 is opposite to the rotation direction of the container assembly 74. The cover plate 4 is equipped with slot-shaped feeding ports 15 with the same quantity of types of the material to be mixed in the present invention. As shown in FIG. 3, the main body of the material barrel welded part 1 in the present invention is a vertical cylindrical shaped material barrel 17. A ring gear 16 with a circular ring used as a top wheel rail at the lower portion of the ring gear 16 is welded to the upper end of the material barrel 17, and a tapered material discharging pipe 18, having an upper end smaller than a lower end, is welded to the lower end of the material barrel 17. A material barrel flange 20 with a machined connection hole is welded to the lower end of the material discharging tapered pipe 18, and one vertical guiding plate 19 in right-angled trapezoid shape positioned vertically is welded to the inner wall of the material discharging tapered pipe 18 at each of four quartering positions, respectively. As shown in FIG. 4, the tapered barrel welded part 7 of the present invention is composed of a tapered barrel 22 having an upper end smaller than a lower end, a disc-shaped top plate 21 welded to the upper end of the tapered barrel 22, and a disc-shaped base plate 23 with one machined key slot at each of the four quartering positions at the outer circumference welded to the lower end of the tapered barrel 22. As shown in FIG. 5, the supporting shaft welded part 8 of the present invention is composed of a cylindrical supporting shaft 24 with a machined screw hole and stage for installing the double direction thrusting bearing at the upper portion and a section of screw rod at the lower portion, and a guiding rod 25 in reversed L-shape made of round steel and welded to the cylindrical supporting shaft 24 at its right side. As shown in FIG. 6, the supporting shaft seat welded part 9 of the present invention is composed of a section of cylindrical tubular supporting seat 27, a disc-shaped guiding plate 26 made of thick steel plate, having a middle hole for allowing the supporting shaft 24 to sildably pass through and a side hole for allowing the guiding rod 25 to pass through, and welded to the upper end of the cylindrical supporting seat 27, and a square flange 28 made of steel plate, having a machined hold and stages for connecting the stepping motor, and welded to the lower end of the cylindrical supporting seat 27. As shown in FIG. 7, the material receiving tapered barrel welded part 10 of the present invention is composed of a conical material receiving barrel 30 whose upper end is larger than the lower end, a material receiving barrel upper flange 29 with a machined connection hole welded to the upper end of the conical material receiving barrel 30, and a material receiving barrel lower flange 31 welded to the lower end of the conical material receiving barrel 30. As shown in FIG. 8, the material discharging tapered barrel welded part 12 of the present invention is composed of a conical material discharging barrel 34 whose upper end is larger than the lower end, a material discharging barrel upper flange 32 welded to the upper end of the conical material discharging barrel 34 and having two bar-shaped horizontal rods 33 welded to the middle of an inner hole of the material discharging barrel upper flange 32, and a material discharging barrel lower flange 35 welded to the lower end of the material discharging barrel 34. As shown in FIG. 9, the structural shape and fabrication process of the frame welded part 14 in the present invention is described as follows. One square cushion plate 37 is welded to the upper portion of each of the three groove steel supporting trestles 38 at a designated position, respectively, and a hole for allowing a screw rod 56 of the top wheel component 5 to pass through is machined at an appointed position. One triangle support 40 is welded to the lower portion of each of the groove steel supporting trestles 38 at a specified position, and a rectangle anchorage plate 41 with anchorage holes is welded to the lower end of the groove steel supporting trestles. Then, after three groove steel supporting trestles 38 which are welded with fittings are placed on trisecting positions of the specified round according to design requirements, a steel round ring 36 with drilled holes for connecting the cover plate 4 is connected to the upper end of the groove steel supporting trestles 38, and a circular rail 39 in circular shape with a circular slot which is circular in the vertical cross-section and machined at the upper end face is welded to the three triangle supports 40 at the lower portion at specified positions. Thus, the frame welded part 14 is formed. As shown in FIG. 10, the beater component 2 in the present invention is composed of several cylindrical stirring bars 44 and a cross-shaped stirring frame 43 horizontally placed, to which the stirring bars are fixed by nut-washers 42. Holes matching the shaft of the speed reducer are machined on the central position of the stirring frame 43. Two or three holes used to install stirring bars 44 are machined, respectively, on each of the horizontal rods extending from four corners, which are vertical to each other. The upper end of the cylindrical stirring bar 44 is a section of screw threads, and besides the smooth rod below the screw threads which matches the installation hole in the stirring frame, there is a stirring bar body to respectively equipped with small scraper plates, scraping blades, sinter abrasive, inlaid polyurethane bands or a section of round steel below the screw threads according to different purposes. Quantity and distribution of the stirring bars 44 shall be determined according to specification and usage conditions of the equipment. As shown in FIG. 11, the scraper plate component 6 of the present invention is composed of a scraper plate frame 45 in a reversed L-shape and a scraper plate 47 in a long bar shape with an edged side, which are fixed together through bolts and nuts 46. Two holes which are used to fix the scraper plate component 6 on the lower end face of the cover plate 4 are drilled in the horizontal plate of the scraper plate frame 45, and two holes which are used to fix the scraper plate 47 are drilled in the vertical plate. Two slotted holes are machined in the scraper plate 47, and the slotted holes are used to adjust positions of the scraper plate 47 when it is fully assembled so that its edge will abut the inner wall of the material barrel 17 and move to the inner wall of material barrel 17 after abrasion. As shown in FIG. 12, the top wheel component 5 of the invention is fabricated by fixing a high strength nylon top wheel 48 installed with one deep groove ball bearing 51 fixed with press plates 49 and screws 50 to an n-shaped top wheel frame 54 with a washer 52, a top wheel shaft 53 and a spring washer 55, and tightening a screw 56 and a nut 57 at the right side of the top wheel frame 54. As shown in FIG. 13, the roller component 11 of the present invention is fabricated by fixing a high strength nylon roller 59 installed with one deep groove ball bearing 60 fixed with press plates 64 and screws 65 into an n-shaped roller frame 58 with a washer 63, a roller shaft 62 and a spring washer 61. There are four machined installation holes at the upper end of the roller frame 58 (for installing the roller component onto the lower end face of the material receiving barrel upper flange). As shown in FIG. 14, the electric material level automatic control device 13 in the present invention is composed of the upper limit sensor 66, the lower limit sensor 67, the bearing box 68, the press plate 69, the tightening screw 70, the double direction thrust bearing 71, the material barrel welded part 1, the tapered barrel bottom welded part 7, the barrel-shaped nut 72, the stepping motor 73, the supporting shaft seat welded part 9, and the supporting shaft welded part 8. The upper limit sensor 66 and lower limit sensor 67 are fixed on the lower end face of the cover plate 4. The double direction thrust bearing 71, bearing box 68 and supporting shaft welded part 8 are integrated through the press plate 69 and the tightening screw 70, and then, the bearing box 68 is fixed on the central position of the lower end face of the tapered barrel bottom welded part 7. Afterwards, the four key slots on the outer circumference of the base plate 23 of the tapered barrel bottom welded part 7 equipped with fittings are aligned with the four vertical guiding plates 19 at the lower end of the material barrel welded part and placed between the material barrel welded part 1 and the material receiving tapered welded part 10. Then, the material barrel welded part 1 and material receiving tapered barrel welded part 10 are integrated with bolts. The middle hole of the guiding disc 26 at the upper end of the supporting shaft seat welded part 9 surrounds the supporting shaft 24, and the small hole at right side surrounds the guiding rod 25. The square flange 28 at the lower end of the supporting shaft seat welded part 9 is fixed on the two horizontal rods 33 at the top end of the material discharging tapered barrel welded part 12 which is placed on the frame 13. After the barrel-shaped nut 72 having a cylindrical external profile, the upper portion of which has a screw hole and the lower portion of which has a machined hole used for matching the shaft of the stepping motor 73, is fixed on the shaft of the stepping motor 73, the barrel-shaped nut 72 together with the stepping motor 73 is tightened onto the lower screw rod of the supporting shaft 24 on a predetermined position, and then the stepping motor 73 is fixed onto the lower end of the supporting shaft seat welded part 9. Thus, the electric material level automatic control device 13 is formed. As shown in FIG. 15, the container assembly 74 in the present invention is composed of the material barrel welded part 1, the material receiving tapered barrel welded part 10, the tapered barrel bottom welded part 7, the double direction thrust bearing 71, the bearing box 68 and three roller components 11. The key slots at outer circumference of the base plate 23 of tapered barrel bottom welded part 7 equipped with fittings such as the double direction thrust bearing 71, the bearing box 68 and the supporting shaft welded part 8, etc., are aligned with the vertical guiding plate 19 on the bottom of the material barrel welded part 1 and placed between the material barrel welded part 1 and the material receiving tapered barrel welded part 10. The material barrel welded part 1 and material receiving tapered barrel welded part 10 are integrated with bolts and nuts, and then three roller components 11 are disposed at a specified location at the lower end face of the material receiving barrel upper flange of the material receiving tapered barrel welded part 10. Thus, the container assembly 74 is formed. As shown in FIG. 16, the drive mechanism 3 in the present invention is composed of the variable frequency control motor 75, the speed reducer 76, the gear 77, the container assembly 74 and three top wheel components 5. The output shaft of the speed reducer 76 installed on the cover plate 4 passes through the cover plate 4 and is directly connected with the beater component 2 in the container assembly 74, and the variable frequency control motor 75 installed on the cover plate 4 engages the gear 77 on its shaft with the ring gear 16 on the material barrel welded part 1 belonging to the container assembly 74. The vertical guiding plates 19 at the lower end of the material barrel welded part 1 are inserted into the key slots at the outer circumference of the tapered barrel bottom welded part 7. The three roller parts of the container assembly 74 are placed on the circular rail 39 at the lower portion of the frame welded part 14, and the three top wheel components are installed at the upper portion of the frame welded part 14 against the top wheel rail at the lower portion of the ring gear which is at the upper portion of the container assembly 74. Thus, the drive mechanism 3 in this invention is formed. The function of the three top wheel components 5 installed on the upper portion of the frame welded part 14 is to change extension length of the top wheel through turning the nut 57 on the screw rod 56, so as to adjust a gap between the ring gear 16 at the upper end of the container assembly 74 and the gear 77 installed at the shaft head of the variable frequency control motor 75 to ensure the well engagement therebetween and the stable operation of the container assembly 74. As shown in FIG. 17, the scraper plate stirring bar 78 adopted by the stirring mixer in the embodiment 1 of the present invention is made by machining slots at a certain angle with respect to the horizontal plane on a cylindrical scraper plate stirring bar body 79, and then welding or adhering strip of small scraper plates 80 to the slots. As shown in FIG. 18, the scraping blade stirring bar 81 adopted by the stirring peeling machine in the embodiment 2 of the present invention is made by machining slots in parallel to its axis on a cylindrical scraping blade stirring bar body 82, and then welding or adhering strips of scraping blade 83 to the slots. As shown in FIG. 19, the sinter abrasive stirring bar 84 adopted by the stirring cleaning machine in the embodiment 3 of the present invention is made by adhering or sintering silicon carbide abrasive 86 to a cylindrical sinter abrasive stirring bar body 85. As shown in FIG. 20, the inlaid polyurethane band stirring bar 87 adopted by the stirring polishing machine in the embodiment 4 of the present invention is made by machining a dovetailed slot in parallel to the axis of a cylindrical inlaid polyurethane band stirring bar body 88 on the cylindrical inlaid polyurethane band stirring bar body 88 and inlaying polyurethane polishing bands 89 which are isosceles trapezoid shaped in the cross-section to the slots. As shown in FIG. 21, the round steel stirring bar 90 adopted by the stirring dampener is made of a round steel bar with smooth surface. As shown in FIG. 22, since only one solid material is used in the stirring peeling machine in embodiment 2, stirring cleaning machine in embodiment 3, stirring polishing machine in embodiment 4 and stirring dampener in embodiment 5 of this invention, the cover plate 4 is equipped with only one slot-shaped feeding port 15, and a spraying pipe 91 is added for feeding water (or other liquid material) or spraying water to prevent dust. As shown in FIG. 23, when the present invention applies the spring automatic material level control equipment, the cylindrical spring seat 93 with a bossing for supporting the spring, is fixed on the horizontal rod at the lower end of the material receiving tapered barrel welded part 9 (for the present invention which applies the spring automatic material level control equipment, the horizontal rod originally installed at the upper end of the material discharging tapered barrel welded part 12 is changed to be disposed at the lower end of the material receiving tapered barrel welded part 9), and the spring 92 placed on the spring seat 93 supports the tapered barrel bottom welded part 7.

There is no material in the container assembly 74 before the present invention works, the tapered barrel bottom welded part 7 is at the highest position, and the container assembly 74 is substantially closed, so that no material discharging and flowing exists. During the operation of the present invention, the speed reducer 76 drives the beater component 2 to rotate, and the variable frequency control motor 75 drives the container assembly 74 to rotate in an opposite direction (the rotation direction of the container assembly 74 is opposite to the rotation direction of the beater component 2) through the engagement between the gear 77 and the ring gear 16, and the mating between the vertical guiding plate 19 at the lower end of the material barrel component 1 and the key slot at the outer circumference of the tapered barrel bottom welded part 7. At the same time, the material to be stirred enters the container assembly 74 through the slot-shaped feeding port 15 at the cover plate 4 along the feeding pipe (not shown in the figures). Since the container assembly 74 rotates at an even speed, the evenly flowing of the material from the slot-shaped feeding port 15 on the fixed cover plate 4 is equivalent to evenly spraying the material to the container assembly 74 layer by layer. More material flowed into the container assembly 74 are accumulated on the tapered barrel bottom welded part 7, and the material level is higher. The present invention does not start working with practical effect until the material touches the stirring bar 44 of the beater component 2 (there is ineffective operation time of several seconds every time the machine begins to work). When height of material accumulated on the tapered barrel bottom welded part 7 has gradually increased and reaches the upper limit value specified by the design, the upper limit sensor 66 starts. The produced signal starts the stepping motor 73 to rotate through a control circuit, the barrel-shaped nut 72 rotates and draws the supporting shaft welded part 8 to drive the tapered barrel bottom welded part 7 and the material accumulated on its upper end to move down. Larger and larger gap will be formed between the outer circumference of the base plate 23 of the tapered barrel bottom welded part 7 and the inner wall of the material discharging tapered pipe 18, more and more material will be discharged from this gap. When the step motor 73 drives the tapered barrel bottom welded part 7 to move down in place, the flow of discharged material reaches the maximum value. The maximum value of the designed flow for the discharged material shall be selected to be more than the designed flow for the feeding material in the present invention. Therefore, after the stepping motor 73 drives the tapered barrel bottom welded part 7 to go down to one specified position, while the flow of the discharged material is bigger than the flow of the feeding material, material level of the container assembly 74 will go down. In order to ensure the material level in container assembly 74 is maintained in one specified range during the operation of the device, a lower limit sensor 67 is specially equipped in the present invention. When the material level in the container assembly 74 goes down to the lower limit value specified by the design, the lower limit sensor 67 starts. The produced signal starts the stepping motor 73 to rotate in an opposite direction through the control circuit, and the barrel-shaped nut 72 rotates in an opposite direction and drives the supporting shaft welded part 8 to rise up with the tapered barrel bottom welded part 7 and the material accumulated on the upper end. The gap between the outer circumference of the tapered barrel bottom welded part 7 and the inner wall of the material discharging tapered pipe 18 is reduced, so that the flow of discharged material is reduced, and the material level in the container gradually rises up until it reaches the upper limit value specified by the design and the upper limit sensor starts . . . the above process repeats. The electric material level automatic control equipment 13 can ensure automatic discharging and flowing of material under its own gravity, and it also ensures that material level of material in the container is maintained between upper limit value and lower limit value specified in the design. The height of the material level in the container assembly 74 and stability of the material level height are important conditions to ensure an excellent and stable process effect and obvious economic benefit of the present invention. The material level height of the present invention is different at different occasions and for different purposes, and the specific value shall be determined by equipment design personnel or users through practical tests. The usage functions of the equipment may be controlled by changing the positions of the probes of the sensors. When the present invention is used for dampening or adding other liquid material, the spraying pipe 91 equipped at the lower end of the cover plate ensures that, the spraying pipe 91 will evenly spray water or other liquid material on the material, while the material evenly flows into the container assembly 74 from the feeding port 15. When the present invention adopts the spring material level automatic control equipment, the spring is compressed by means of the gravity of the tapered barrel bottom welded part 7 and the material accumulated on its upper end, and then the gaps with various sizes may be formed between the outer circumference of the tapered barrel bottom welded part 7 and the inner wall of the material discharging tapered pipe 18, which realizes the purpose of providing an automatic discharging and flowing channel for the material and controlling the material level in the container assembly 74.

According to the above description, the respective advantages of the five embodiments in the present invention are described as follows.

1. Advantages of the Stirring Mixer

The stirring mixer is a kind of continuous mixing equipment. When high mixing accuracy is required, several (the quantity equals to the quantity of types of the material to be mixed) quantitative material feeders shall be used with the stirring mixer. The material conveyed by the quantitative material feeders in a set proportion is evenly sprayed into the container through slot-shaped feeding ports on the fixed cover plate. Analyzed according to an ideal state, the volume of each composition should be approximately the same when any material of a certain volume are taken along the vertical direction to the material layers for a comparison to each other, even if the stirring does not occur. That is, as soon as each type of materials enters the container, it is in a macroscopic even distribution state. Since the material is basically in an even distribution state as soon as the material enters the container during the operation of the present invention, the purpose of even mixing can be realized as long as the beater forces all types of material to move up and down, left and right crossly in a small area near its initial position and to be mixed with each other. Compared to the methods of feeding material with large flow in an accumulated form and stirring and mixing in a large area in the prior art, it has obvious advantages that the mixing work load is greatly reduced, the mixing time is shortened and the energy consumption is greatly reduced. After the material to be mixed enters into the quantitative material feeder, the whole process is carried out in an enclosed container or pipes until the mixed material enters the next process. Therefore, the present invention has the advantages of continuous mixing equipments, such as compact structure, reduced segregation phenomenon occurred during conveying and storage process, adaptability for continuous and automatic production demand, and reduced environment pollution, etc. In particular, since only the material around the stirring bar is stirred by the beater to move upwards and downwards, leftwards and rightwards and turning during the operation of the present invention, the movement of diffusing, contra-flowing and shear mixing is minor, Moreover, restricted by upper layer material continuously sprayed into the container and the surrounding material particles, almost all material particles cannot move according to the rule of automatic sizing. Thus, the segregation tendency is minor during the operation of the present invention. Therefore, the present invention has obvious advantages when it is used for mixing the material with big characteristic difference in granularity, density, shape, surface roughness and flowability, etc. Furthermore, the beater and stirring bar in the present invention have obvious advantages of simple structure, low cost, easy use and maintenance, long lifespan, etc.

2. Advantages of the Stiffing Peeling Machine

When the present invention is used as a stirring peeling machine, each grain in the container only bears scraping force of the stirring bar and binding force formed by the compression of surrounding material, which are a group of forces with equal quantity and in opposite directions. Each grain in a loose accumulation state can freely turn over and move when it is subjected by an external force, and the binding force on the grain which is transferred from static pressure determined by material level height is far less than a broken force which can break the grains. Therefore, the present invention has the advantage that no breaking of grains occurs during operation of the present invention. Since the design of the present invention ensures no dead corner of stirring, all grains entering the container has the approximate equal opportunity for stirring. All grains will be scraped by the scraping blade and rubbed by the surrounding grain for several tens of times during the discharging and flowing process for several hundreds of millimetre from an upper position to a lower position, so that the peeling rate is obvious higher than that in the prior art. Since the material automatically discharges and flows under its own weight during the operation of the stirring peeling machine, and it is not necessary for the equipment to provide power to the material for the motion in a horizontal direction and maintaining the pressure in a grinding room, the energy consumption is obviously reduced during the operation of the present invention. Since the stirring peeling machine adopts the stirring bar installed with tool steel scraping blades with excellent abrasion resistant performance along the axis of the round steel bar, the service life of the wearing part is long.

3. Advantages of the Stirring Cleaning Machine

The stirring cleaning machine adopts the stirring bar with adhered or sintered silicon carbide abrasive. The acting force applied by the beater of the stirring cleaning machine to the material particle is a pure friction force, and no high strength impact force which causes grains to break exists, so no broken grain is a great advantage of the present invention. Compared to the prior art, all material particles entering the container has more and relatively more even possibility to be stirred and rubbed during the operation of the present invention, so that the working efficiency and process effect of the present invention are greatly higher than those of the prior art. Furthermore, the abrasion resistant performance of the sinter abrasive stirring bar adopted by the stirring cleaning machine is also higher than that of the prior art.

4. Advantages of the Stirring Polishing Machine

The stirring polishing machine adopts the stirring bar with inlaid polyurethane polishing bands. As the friction force applied by the polyurethane polishing bands is mild and the damage for the surface of the grains is less, the possibility for the grains to be stirred and rubbed is even and the possibility value is far more than that of the prior art during the operation of the stirring polishing machine. Therefore, the stirring polishing machine has obvious advantages of no broken grain, low loss, good polishing effect, low energy consumption, long service life, simple installation and maintenance, etc.

5. Advantages of the Stirring Dampener (Solid-liquid Mixing Equipment)

Because the flowability and adhesion of liquid material are good, the purpose of wetting by adhering water may be realized just by forcing the solid material particles to roll approximately at the original location through stirring during slow discharging and flowing process of the solid material particles. In order to reduce the damage on the material particles caused by the stirring bar during the operation of the stirring dampener, the stirring dampener adopts a cylindrical steel stirring bar with smooth surface. Since the material automatically flows down by means of its own weight, energy consumed by the stirring bar with smooth surface is very little during the operation of the stirring bar, so that the stirring dampener has obvious advantages of minor damaging on material particles, even water adhering, energy saving and consumption reducing, etc.

1. A multifunctional stirrer comprising a frame, a container, a beater and a driving mechanism, characterized in that: a circular rail is installed at a lower portion of the frame; a bottom of the vertical cylindrical shaped container is a conical shaped barrel bottom which can be driven to move up and down by a lifting mechanism automatically; the driving mechanism drives a container assembly to rotate on the circular rail of the frame in a direction opposite to a rotation direction of the beater while driving the beater to rotate; the beater is composed by fixing a plurality of stirring bars onto a horizontally arranged stirring bar frame; and a rotation axis of the stirring bar frame is eccentrically disposed with respect to an axis of the vertical cylindrical shaped container.

2. The multifunctional stirrer according to claim 1, characterized in that the lifting mechanism is controllably connected to an electric automatic control device or a spring automatic control device.

3. The multifunctional stirrer according to claim 1, wherein the stirring bar frame of the beater is cross-shaped; the stirring bar frame is equipped with the stifling bars selected from a group of scraper plate stirring bars, scraping blade stirring bars, sinter abrasive stirring bars and inlaid polyurethane band stirring bars, according to usage requirements; the minimum distance between the outermost stirring bar and the inner wall of the container ranges from 10 mm to 15 mm, and a scraper plate component is disposed at a position of the inner wall of the container far away from the stifling bars.

4. The multifunctional stirrer according to claim 2, characterized in that the automatic electrical control device is composed of an upper limit sensor, a lower limit sensor, a bearing box, a press plate, a tightening screw, a double direction thrust bearing, a tapered barrel bottom welded part, a barrel-shaped nut, a stepping motor, a supporting shaft seat welded part and a supporting shaft welded part, wherein the supporting shaft welded part is composed of a cylindrical supporting shaft with a machined screw hole and a stage for installing the double direction thrust bearing at an upper portion thereof and a section of screw rod at a lower portion thereof, and a reversed L-shaped guiding rod made by rounded steel bar is welded to the right side of the cylindrical supporting shaft; the supporting shaft seat welded part is composed of a section of cylindrical tubular supporting seat, an upper end of which is welded to a disc-shaped guiding plate, wherein the disc-shaped guiding plate is made by a thick steel plate, having a middle hole allowing the supporting shaft to slidably pass through and a side hole allowing the guiding rod to pass through, and an lower end of which is welded to a square flange, wherein the square flange is made by a steel plate, having a machined hole and a stage for connecting the stepping motor; an upper portion of the barrel-shaped nut is an internal screw thread to match with the screw rod at the lower portion of the supporting shaft welded part, and a lower portion of the barrel-shaped nut is a cylindrical part with a rounded hole to match with a shaft of the stepping motor; the upper limit sensor and the lower limit sensor are fixed on a cover plate; a flange at a lower end of the supporting shaft seat welded part is fixed on two transverse rods of an upper end of a material discharging barrel welded part; an upper end of the supporting shaft seat welded part matches the supporting shaft welded part connected to the tapered barrel bottom with a bearing box installing the thrust bearing; screw threads at the lower portion of the supporting shaft welded part matches the barrel-shaped nut fixed on the shaft of the stepping motor; the stepping motor is fixed at the lower end of the supporting shaft seat welded part; when the present invention works, the stepping motor can be driven by signals from the upper limit sensor and the lower limit sensor via a control system to lift the tapered barrel bottom up and down.

5. The multifunctional stirrer according to claim 2, characterized in that the automatic spring control device is composed of a spring and a cylindrical spring seat fixed at the bottom of the container having a bossing for supporting the spring.

6. The multifunctional stirrer according to claim 3, characterized in that the scraper plate stirring bar is made by machining a slot at a certain angle with respect to a horizontal plane in a steel cylindrical scraper plate stirring bar body, and welding or adhering a strip of small scraper plate to the slot.

7. The multifunctional stirrer according to claim 3, characterized in that the scraping blade stirring bar is made by machining a slot parallel to the axis of a scraping blade stirring bar body in the steel cylindrical scraping blade stifling bar, and welding or adhering a strip of scraping blade to the slot.

8. The multifunctional stirrer according to claim 3, characterized in that the sinter abrasive stirring bar is made by adhering or sintering silicon carbide abrasive to a steel cylindrical sinter abrasive stirring bar body.

9. The multifunction stirrer according to claim 3, characterized in that the inlaid polyurethane band stifling bar is made by machining a dovetailed slot parallel to the axis of a steel cylindrical inlaid polyurethane band stirring bar body in the steel cylindrical inlaid polyurethane band stirring bar body and inlaying to the dovetailed slot a polyurethane polishing band of isosceles trapezoid shape in cross-section.

10. The multifunctional stirrer according to claim 1, characterized in that the frame welded part includes three groove steel supporting trestles, wherein a square cushion plate is welded on an upper portion of each of the groove steel supporting trestles at a specified position, and a hole for allowing a screw rod of a top wheel component to pass through is machined at a specified position thereof; a triangle support is welded on a lower portion of each of the groove steel supporting trestles at an appointed position, and a rectangle anchorage plate with an anchorage hole is welded to each of low ends of the groove steel support trestles; then after the three groove steel supporting trestles with welded fittings are placed on trisecting positions of a specified circle according to design requirements, a steel round ring with drilled holes for connecting the cover plate is welded to an upper end of the groove steel supporting trestles; a circular rail with a circular slot machined at an upper end face of the circular rail is welded to the lower portion of the three triangle supports at appointed positions, wherein the circular slot is rounded in a vertical cross-section; and thus the frame welded part is formed.

11. The multifunctional stirrer according to claim 10, characterized in that the container assembly is composed of a material barrel welded part, a material receiving tapered barrel welded part, a tapered barrel bottom welded part, a double direction thrust bearing, a bearing box and three roller components, wherein a main body of the material barrel welded part is a vertical cylindrical shaped material barrel, a ring gear of which a lower portion is a section of circular ring used as a top wheel rail is welded to an upper end of the material barrel; a material discharging tapered barrel of which a lower end is bigger than an upper end thereof is welded to a lower end of the material barrel; a material barrel flange with machined connection holes is welded to the lower end of the material discharging tapered barrel, a vertical guiding plate of right-angled trapezoid shape which is placed vertically is welded on each of quartering positions at the inner wall of the material discharging tapered pipe; the material receiving tapered barrel welded part is composed of the material receiving tapered barrel having an upper end bigger than a lower end thereof, a material receiving barrel upper flange with machined connection holes which is welded to an upper end of the material receiving tapered barrel, and a material receiving barrel lower flange which is welded to a lower end of the material receiving tapered barrel; the tapered barrel bottom welded part is composed of a tapered barrel of which an upper end is smaller than a lower end thereof, a disc-shaped top plate which is welded to the upper end of the tapered barrel, and a disc-shaped base plate with a key slot machined at each of quartering positions on the outer circumference, which is welded to the lower end of the tapered barrel; the tapered barrel bottom welded part, installed with fittings such as the double direction thrust bearing, the bearing box, the supporting shaft welded part, etc., is placed between the material barrel welded part and the material receiving tapered barrel welded part in a manner of that the key slots on the outer circumference of the base plate of the tapered barrel bottom welded part are aligned with the vertical guiding plates at the bottom of the material barrel welded part, the material barrel welded part and the material receiving tapered barrel welded part are fixed into a whole with bolts and nuts, and then the three roller components are installed at a lower end face of the material receiving barrel upper flange of the material receiving tapered barrel welded part at appointed positions, thus, the container assembly is formed.

12. The multifunction stirrer according to claim 11, characterized in that the driving mechanism is composed of a variable frequency control motor, a speed reducer, a gear, the container assembly and three top wheel components; an output shaft of the speed reducer installed on the cover plate is directly connected with the beater component in the container component by passing through the cover plate, and the variable frequency control motor installed on the cover plate is engaged the gear installed on its shaft with a ring gear fixed at an upper end of the container assembly; the four vertical guiding plates belonging to the container assembly at a lower end of the material barrel welded part are inserted into the four key slots at the outer circumference of the tapered barrel bottom; the speed reducer drives the beater to rotate; the variable frequency control motor drives the whole container assembly together with material in the container to rotate on the circular rail of the frame through the engagement between the gear and the ring gear, and the mating between the vertical guiding plates and the key slots; and the horizontal position of the container assembly can be adjusted by adjusting the positions of nuts on the screw rods of the three top wheel components installed at the upper portion of the frame welded part so as to ensure good engagement between the gear and the ring gear and stable operation of the container assembly.

13. The multifunctional stirrer according to claim 2, characterized in that the frame welded part includes three groove steel supporting trestles, wherein a square cushion plate is welded on an upper portion of each of the groove steel supporting trestles at a specified position, and a hole for allowing a screw rod of a top wheel component to pass through is machined at a specified position thereof; a triangle support is welded on a lower portion of each of the groove steel supporting trestles at an appointed position, and a rectangle anchorage plate with an anchorage hole is welded to each of low ends of the groove steel support trestles; then after the three groove steel supporting trestles with welded fittings are placed on trisecting positions of a specified circle according to design requirements, a steel round ring with drilled holes for connecting the cover plate is welded to an upper end of the groove steel supporting trestles; a circular rail with a circular slot machined at an upper end face of the circular rail is welded to the lower portion of the three triangle supports at appointed positions, wherein the circular slot is rounded in a vertical cross-section; and thus the frame welded part is formed.

14. The multifunctional stirrer according to claim 3, characterized in that the frame welded part includes three groove steel supporting trestles, wherein a square cushion plate is welded on an upper portion of each of the groove steel supporting trestles at a specified position, and a hole for allowing a screw rod of a top wheel component to pass through is machined at a specified position thereof; a triangle support is welded on a lower portion of each of the groove steel supporting trestles at an appointed position, and a rectangle anchorage plate with an anchorage hole is welded to each of low ends of the groove steel support trestles; then after the three groove steel supporting trestles with welded fittings are placed on trisecting positions of a specified circle according to design requirements, a steel round ring with drilled holes for connecting the cover plate is welded to an upper end of the groove steel supporting trestles; a circular rail with a circular slot machined at an upper end face of the circular rail is welded to the lower portion of the three triangle supports at appointed positions, wherein the circular slot is rounded in a vertical cross-section; and thus the frame welded part is formed.

15. The multifunctional stirrer according to claim 4, characterized in that the frame welded part includes three groove steel supporting trestles, wherein a square cushion plate is welded on an upper portion of each of the groove steel supporting trestles at a specified position, and a hole for allowing a screw rod of a top wheel component to pass through is machined at a specified position thereof; a triangle support is welded on a lower portion of each of the groove steel supporting trestles at an appointed position, and a rectangle anchorage plate with an anchorage hole is welded to each of low ends of the groove steel support trestles; then after the three groove steel supporting trestles with welded fittings are placed on trisecting positions of a specified circle according to design requirements, a steel round ring with drilled holes for connecting the cover plate is welded to an upper end of the groove steel supporting trestles; a circular rail with a circular slot machined at an upper end face of the circular rail is welded to the lower portion of the three triangle supports at appointed positions, wherein the circular slot is rounded in a vertical cross-section; and thus the frame welded part is formed.

16. The multifunctional stirrer according to claim 5, characterized in that the frame welded part includes three groove steel supporting trestles, wherein a square cushion plate is welded on an upper portion of each of the groove steel supporting trestles at a specified position, and a hole for allowing a screw rod of a top wheel component to pass through is machined at a specified position thereof; a triangle support is welded on a lower portion of each of the groove steel supporting trestles at an appointed position, and a rectangle anchorage plate with an anchorage hole is welded to each of low ends of the groove steel support trestles; then after the three groove steel supporting trestles with welded fittings are placed on trisecting positions of a specified circle according to design requirements, a steel round ring with drilled holes for connecting the cover plate is welded to an upper end of the groove steel supporting trestles; a circular rail with a circular slot machined at an upper end face of the circular rail is welded to the lower portion of the three triangle supports at appointed positions, wherein the circular slot is rounded in a vertical cross-section; and thus the frame welded part is formed.

17. The multifunctional stirrer according to claim 6, characterized in that the frame welded part includes three groove steel supporting trestles, wherein a square cushion plate is welded on an upper portion of each of the groove steel supporting trestles at a specified position, and a hole for allowing a screw rod of a top wheel component to pass through is machined at a specified position thereof; a triangle support is welded on a lower portion of each of the groove steel supporting trestles at an appointed position, and a rectangle anchorage plate with an anchorage hole is welded to each of low ends of the groove steel support trestles; then after the three groove steel supporting trestles with welded fittings are placed on trisecting positions of a specified circle according to design requirements, a steel round ring with drilled holes for connecting the cover plate is welded to an upper end of the groove steel supporting trestles; a circular rail with a circular slot machined at an upper end face of the circular rail is welded to the lower portion of the three triangle supports at appointed positions, wherein the circular slot is rounded in a vertical cross-section; and thus the frame welded part is formed.

18. The multifunctional stirrer according to claim 7, characterized in that the frame welded part includes three groove steel supporting trestles, wherein a square cushion plate is welded on an upper portion of each of the groove steel supporting trestles at a specified position, and a hole for allowing a screw rod of a top wheel component to pass through is machined at a specified position thereof; a triangle support is welded on a lower portion of each of the groove steel supporting trestles at an appointed position, and a rectangle anchorage plate with an anchorage hole is welded to each of low ends of the groove steel support trestles; then after the three groove steel supporting trestles with welded fittings are placed on trisecting positions of a specified circle according to design requirements, a steel round ring with drilled holes for connecting the cover plate is welded to an upper end of the groove steel supporting trestles; a circular rail with a circular slot machined at an upper end face of the circular rail is welded to the lower portion of the three triangle supports at appointed positions, wherein the circular slot is rounded in a vertical cross-section; and thus the frame welded part is formed.

19. The multifunctional stirrer according to claim 8, characterized in that the frame welded part includes three groove steel supporting trestles, wherein a square cushion plate is welded on an upper portion of each of the groove steel supporting trestles at a specified position, and a hole for allowing a screw rod of a top wheel component to pass through is machined at a specified position thereof; a triangle support is welded on a lower portion of each of the groove steel supporting trestles at an appointed position, and a rectangle anchorage plate with an anchorage hole is welded to each of low ends of the groove steel support trestles; then after the three groove steel supporting trestles with welded fittings are placed on trisecting positions of a specified circle according to design requirements, a steel round ring with drilled holes for connecting the cover plate is welded to an upper end of the groove steel supporting trestles; a circular rail with a circular slot machined at an upper end face of the circular rail is welded to the lower portion of the three triangle supports at appointed positions, wherein the circular slot is rounded in a vertical cross-section; and thus the frame welded part is formed.

20. The multifunctional stirrer according to claim 9, characterized in that the frame welded part includes three groove steel supporting trestles, wherein a square cushion plate is welded on an upper portion of each of the groove steel supporting trestles at a specified position, and a hole for allowing a screw rod of a top wheel component to pass through is machined at a specified position thereof; a triangle support is welded on a lower portion of each of the groove steel supporting trestles at an appointed position, and a rectangle anchorage plate with an anchorage hole is welded to each of low ends of the groove steel support trestles; then after the three groove steel supporting trestles with welded fittings are placed on trisecting positions of a specified circle according to design requirements, a steel round ring with drilled holes for connecting the cover plate is welded to an upper end of the groove steel supporting trestles; a circular rail with a circular slot machined at an upper end face of the circular rail is welded to the lower portion of the three triangle supports at appointed positions, wherein the circular slot is rounded in a vertical cross-section; and thus the frame welded part is formed.
